(19) United States
(12) Patent Application Publication
(10) Pub. No.: US 2011/0074542 A1
(43) Pub. Date: Mar. 31, 2011

(54) Monitoring and control system and monitoring and control device

(75) Inventors: Hideo Nabeshima, Hirakata-shi (JP); Mari Nakanishi, Osaka-shi (JP)

(73) Assignee: Panasonic Electric Works Co., Ltd., Osaka (JP)

(21) Appl. No.: 12/923,458

(22) Filed: Sep. 23, 2010

(30) Foreign Application Priority Data
Sep. 25, 2009 (JP) 2009-221096
Sep. 25, 2009 (JP) 2009-221186
Sep. 25, 2009 (JP) 2009-221187

(51) Int. Cl. G06F 7/04

(52) U.S. Cl. 340/5.62

(57) ABSTRACT

A remote monitoring and control system includes a monitoring and control device operated to control loads; and a load control device for controlling the loads based on the operation of the monitoring and control device. The monitoring and control device includes: a display unit for displaying an operation screen including operation keys for controlling corresponding loads; an input receiving unit for receiving an input through the displayed operation keys; a reading unit for reading out a user ID; a storage unit for storing load-identifying information identifying loads and control information having control contents of the loads; and a determining unit for searching the storage unit if a user ID is read out, and determining the load-identifying information and the control information which correspond to the user ID, and the load control device controls the loads identified based on the load-identifying information, depending on the control contents of the control information.

### FIELD OF THE INVENTION

The present invention relates to a remote monitoring and control system which monitors and controls a load such as a lighting device and a monitoring and control device used therein.

### BACKGROUND OF THE INVENTION

A conventional remote monitoring and control system includes, for example, an operation terminal having a plurality of operation buttons for controlling a load, the operation terminal serving as a monitoring and control device; a control terminal having therein a relay circuit for turning on and off a power switch of the load; and a transmission control device connected to the operation terminal and the control terminal, respectively, by signal lines (see, e.g., Japanese Patent Application Publication No. H10-243478 (JP10-243478A1)).

In such system, addresses are individually allotted to the load and the operation buttons of the operation terminal.

Once the operation terminal receives an input of a specific operation button, a signal is transmitted from the operation terminal to the control terminal through the transmission control device. The signal includes information of the address allotted to the specific operation button; and load control contents, such as on/off information and the like. The control terminal receives the signal and performs, e.g., an on/off control of a power switch for a load having an address corresponding to the address included in the signal in accordance with the control contents included in the signal.

In JP10-243478A1, there has been disclosed a “multi-functional switch” including a display unit and a transparent touch sensor combined with the display unit, as an example of the operation terminal. In the multi-functional switch, the operation buttons corresponding to respective loads are displayed on a screen of the display unit and inputs of operation buttons are received by detecting portions that are touched on the screen.

Moreover, in the multi-functional switch, display contents such as kinds of the operation buttons (keys) displayed on the screen is freely changeable, so that it is possible to control various loads by using one multi-functional switch.

In the meantime, the conventional remote monitoring and control system is used in on/off controls of lighting devices in an office building, for example. Some users turn on the same lighting devices whenever entering a room of the office building and may feel cumbersome when operating the operation terminal in the same way each time. Further, if operation buttons are configured and displayed uniformly to all users as in the conventional method, for a user, a frequently used operation button may inconveniently be omitted or displayed on a position where it becomes difficult for the user to manipulate it.

Furthermore, although it is possible to conveniently control remotely positioned loads by using the conventional remote monitoring and control device, it may lead to leaking information to display operation buttons for controlling loads by the multi-functional switch. For example, when the conventional remote monitoring and control device controls loads, i.e., lighting devices, to be tuned on and off in the office building, the configuration, detailed lighting information and the like of the office building may carelessly be displayed, and such information of the office building may be illegally abused by an offender to break into the office building.

Besides, if the multi-functional switch is open to the public without being limited to the authorized staffs, the loads may be used unnecessarily, causing energy wastes.

### SUMMARY OF THE INVENTION

In view of the above, the present invention provides a remote monitoring and control system, capable of controlling loads to be adequate for a user with less manipulation.

The present invention also provides a monitoring and control device, capable of configuring and displaying operation keys for controlling loads to be adequate for each user.

Further, the present invention provides a monitoring and control device, capable of adequately determining whether or not an operation screen is displayed depending on whether or not a user has the authority.

In accordance with an aspect of the present invention, there is provided a remote monitoring and control system. The system includes a monitoring and control device being operated to control one or more loads; and a load control device for controlling the loads based on the operation of the monitoring and control device. The monitoring and control device includes: a display unit for displaying an operation screen including one or more operation keys for controlling corresponding ones of the loads; an input receiving unit for receiving an input of the displayed operation keys; a reading unit for reading out a user ID; a storage unit for storing load-identifying information identifying loads and control information having control contents of the loads in a corresponding relationship to each user ID; and a determining unit for searching the storage unit if a user ID is read out by the reading unit, and determining the load-identifying information and the control information which correspond to the read-out user ID, and the load control device controls the loads identified based on the load-identifying information determined by the determining unit, depending on the control contents of the control information determined by the determining unit.

With such configuration, the monitoring and control device transmits a transmission signal including address information of a load(s) corresponding to a user ID and corresponding control content information. Accordingly, the load control device can control the load(s) based on the control content information. For that reason, it is possible to perform the user-customized control of the load(s) by presetting the address information of a target load(s) and corresponding control content information for each user ID.

Moreover, the input receiving unit may include a touch sensor, provided on the display unit, for detecting a position touched on the operation screen and, if a touched position is detected by the touch sensor, receives an input of the operation key displayed at the touched position detected by the touch sensor.

The reading unit may read out the user ID from a tag including a battery, the tag transmitting the user ID by a power supplied from the battery.

Moreover, the reading unit may include an antenna and induces a power to a non-contact IC card including another antenna to read out the user ID from the non-contact IC card

The monitoring and control device connected to a load control device for controlling one or more loads and installed separately from the loads. The monitoring and control device includes: a display unit for displaying an operation screen including one or more operation keys for controlling corresponding ones of the loads; a touch sensor, provided on the display unit, for detecting a position touched on the operation screen; an input receiving unit for receiving an input of an operation key displayed at the touched position detected by the touch sensor; a reading unit for reading out a user ID; a storage unit for storing load-identifying information identifying loads and control information having control contents of the loads in a corresponding relationship to each user ID; a determining unit for searching the storage unit if a user ID is read out by the reading unit and determining the load identifying information and the control information which correspond to the read-out user ID; and a transmission unit for transmitting to the load control device the load-identifying information and the control information determined by the determining unit

In accordance with another aspect of the present invention, there is provided a monitoring and control device used in a remote monitoring and control system including the monitoring and control device and a load control device for controlling one or more loads based on an operation of the monitoring and control device, the monitoring and control device being operated to control the loads. The device includes: a display unit for displaying an operation screen including one or more operation keys for controlling corresponding ones of the loads; a touch sensor, provided on the display unit, for detecting a position touched on an operation screen; a reading unit for reading out a user ID; a storage unit for storing user IDs and a plurality of display data used to display the operation screen, the display data respectively corresponding to the user IDs; a determining unit for determining one of the display data based on the user ID that is read out by the reading unit; a display controller for displaying the operation screen including the operation keys on the display unit by using the determined display data; and an input receiving unit for receiving an input of the operation key displayed at the touched position detected by the touch sensor.

With such configuration, since the display controller displays on the display unit the operation screen using the display data corresponding to the user ID, it is possible to display user-customized operation keys by correspondingly pre-storing, for each user ID, the display data adequate for the users in the storage unit, thereby improving the user's convenience.

Moreover, at least one of the display data stored in the storage unit may correspond to at least two of the user IDs.

Accordingly, by storing one display datum user-customized to control the loads of, e.g., a room A and a plurality of user IDs of users who use the same room A, it is possible to display an operation screen having the operation keys displayed by using the user-customized display datum to the users who use the room A.

The operation screen may include a plurality of tabs, each of which has at least one operation key, and the display controller may display on the display unit the operation screen including a plurality of tab keys indicating the tabs and at least one operation key included in one selected from the tab keys; and, if the input receiving unit receives an input of a tab key that is not selected, displays the operation screen including the tab keys and at least one operation key included in the tab corresponding to the input.

Accordingly, by selecting tab keys for changing the operation keys displayed, it is possible to display many operation keys even when the display unit has a small size.

In accordance with still another aspect of the present invention, there is provided a monitoring and control device used in a remote monitoring and control system including the monitoring and control device and a load control device for controlling one or more loads based on an operation of the monitoring and control device, the monitoring and control device being operated to control the loads. The device includes: a reading unit for reading out a user ID; an authentication unit for performing an authentication based on the user ID; a display controller for displaying an operation screen for controlling a load on a display unit if the authentication by the authentication unit is succeeded, and suppressing the operation screen from being displayed on the display unit if the authentication is failed; an input receiving unit for receiving an input through the operation screen; and a transmission unit for transmitting operation information related to the received input to the load control device.

With such configuration, if the authentication is succeeded, the display controller can display the operation screen to receive an input from a user. On the other hand, if the authentication is failed, the display controller can prevent a user having no authority from controlling the load by displaying no operation screen.

Moreover, the reading unit may read out the user IDs and history information including entering authentication records from a storage medium carried by a user, and the display controller may not display the operation screen on the display unit if the authentication records included in the history information does not satisfy a predetermined condition even when the authentication by the authentication unit is succeeded.

Accordingly, if the predetermined condition is based on whether the entering authorization record, the display controller can display the operation screen to the users who carry the record mediums having the entering authorization records and, on the other hand, prevent the operation screen from being displayed to the uses who carry the record mediums having no entering authorization record.

Further, if the authentication records included in the history information do not satisfy the predetermined condition, the display controller may display on the display unit an urging screen for urging users to obtain a normal entering authentication record.

Accordingly, if the predetermined condition is based on whether the entering authorization record, it is possible to urge a user who has the entering authority but forgets to perform the entering authorization to perform the normal authorization, thereby improving the accuracy of the entering/leaving management.

Further, if the authentication records included in the history information do not satisfy the predetermined condition, notification information indicating an abnormal access is transmitted to a preset target place.

Accordingly, when the preset target place is a management server of the entering/leaving management system, it is possible to adequately cope with the suspicious users who have no authority.

The device may further include: an obtaining unit for obtaining an operation state of each load, and the operation screen displayed by the display unit may further include the obtained operation states.

With such configuration, it is possible to determine whether there is displayed such information that is easily to be abused by an offender who tries to break into the office building depending on whether the authorization is succeeded or failed.

### BRIEF DESCRIPTION OF THE DRAWINGS

The objects and features of the present invention will become apparent from the following description of embodiments, given in conjunction with the accompanying drawings, in which:

FIG. 1 shows a configuration of a remote monitoring and control system in accordance with a first embodiment of the present invention;

FIG. 2 is a floor view of a P company showing one floor of an office building in accordance with the first embodiment of the present invention;

FIG. 3 is a block diagram showing a touch switch in accordance with the first embodiment of the present invention;

FIG. 4 shows a data configuration of an ID-load database;

FIG. 5 shows a data configuration of an ID-display sheet database;

FIG. 6 shows a data configuration of a display sheet database in accordance with the first embodiment of the present invention;

FIG. 7 shows a data configuration of an operation state table;

FIG. 8 shows a format of a transmission signal;

FIG. 9 is a flowchart showing the process of the touch switch;

FIG. 10 is a flowchart showing the process of the touch switch;

FIG. 11A shows that the touch switch reads out an ID from a tag of a user;

FIG. 11B shows an operation screen of the touch switch;

FIGS. 12A and 12B are floor views before and after a user ID “ID:0001” is read;

FIG. 13A is a block diagram showing a reading unit;

FIG. 13B is a block diagram showing the tag;

FIG. 14 is a schematic view showing the touch switch;

FIG. 15 shows a room where one load that is turned on and the other loads is turned off;

FIG. 16 is a view for explaining a sensor standby mode of two loads in a men's rest room;

FIG. 17 shows a data configuration of an ID-display sheet database;

FIG. 18A shows a data configuration of a group-display sheet data base;

FIG. 18B shows a data configuration of a group-ID database;

FIG. 19 shows an operation screen of the touch switch;

FIG. 20 shows a configuration of a remote monitoring and control system in accordance with a second embodiment of the present invention;

FIG. 21 is a floor view of a P company showing one floor of an office building in accordance with the second embodiment of the present invention;

FIG. 22 is a block diagram showing a touch switch in accordance with the second embodiment of the present invention;

FIG. 23 shows a data configuration of an authority database;

FIG. 24 shows a data configuration of a display sheet database in accordance with the second embodiment of the present invention;

FIG. 25 is a flowchart showing an example of the process of the touch switch;

FIG. 26A shows that the touch switch reads an ID from a tag of a user;

FIG. 26B shows an operation screen of the touch switch after the ID is read;

FIG. 27A shows that the touch switch reads an ID from a tag of another user;

FIG. 27B shows an operation screen of the touch switch after the ID is read;

FIG. 28 is a flowchart showing another example of the process of the touch switch;

FIG. 29A shows that the touch switch reads an ID from a tag of still another user;

FIG. 29B shows an operation screen of the touch switch after the ID is read;

FIG. 30 shows how a notification is made from the touch switch to an access managing system;

FIG. 31 shows a setting screen for setting names of operation keys; and

FIG. 32 shows an operation screen of the touch switch.

### DETAILED DESCRIPTION OF THE EMBODIMENTS

Embodiments of the present invention will now be described with reference to the accompanying drawings which form a part hereof.

### First Embodiment

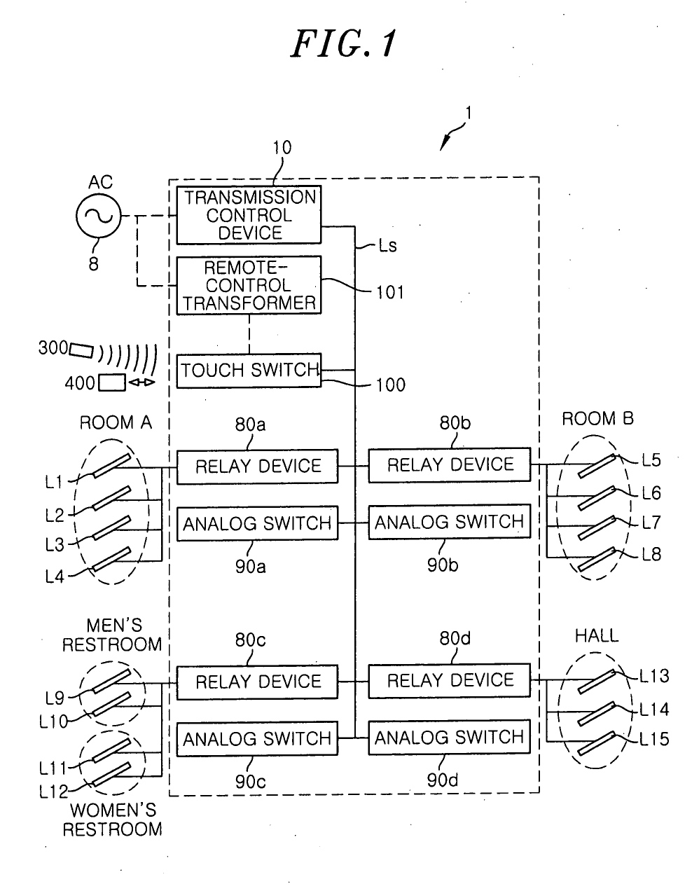

First, a first embodiment of the present invention will be described. As shown in FIG. 1, a remote monitoring and control system 1 includes a transmission control device 10, four relay devices 80a to 80d, four analog switches 90a to 90d, and a touch switch 100 serving as a monitoring and control device.

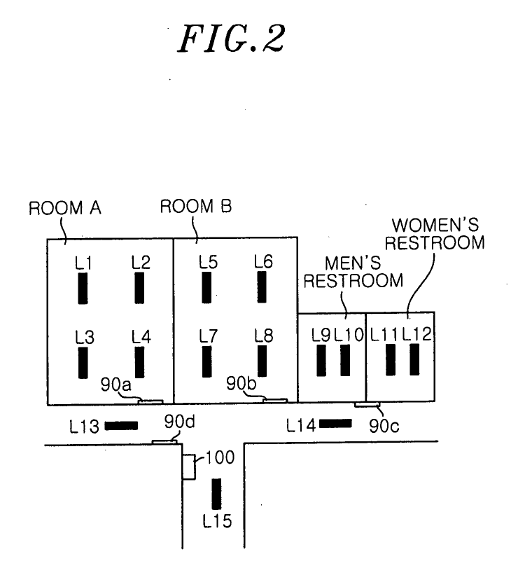

FIG. 2 is a floor view of one floor of an office building which is occupied by a P company. The remote monitoring and control system 1 of the present embodiment is applied to the floor of the office building. As shown in FIG. 2, loads L1 to L4 are installed at ceiling portions of a room A; and an analog switch 90a for controlling the loads L1 to L4 is provided at a wall surface of the room A near an entrance thereof.

Similarly, loads L5 to L8 are installed at ceiling portions of a room B, and an analog switch 90b for controlling the loads L5 to L8 is provided at a wall surface of the room B near an entrance thereof. A men's rest room includes loads L9 and L10, and a women's rest room includes loads L11 and L12. An analog switch 90c for controlling the load L9 to L12 is installed at an entrance for the men's and the women's rest room. In addition, a hall includes loads L13 to L15; and an analog switch 90d for controlling the loads L13 and L15. The loads L1 to L15 are lighting devices in the present embodiment.

Further, the touch switch 100 for controlling all the loads L1 to L15 is installed at the hall. The remote monitoring and control system 1 will be briefly described hereinafter. Specific addresses are respectively assigned to the analog switches 90a to 90d, the touch switch 100 and the loads L1 to L15. Each user carries a tag 300 or an IC card 400 where an inherent user ID of the user is written.

If a user ID is read out from the tag 300 of a user, a touch switch 100 determines a load(s) corresponding to the user ID and a control content(s) for the load(s). Then, the touch switch 100 transmits to the transmission control device 10 a signal having address information of the determined load(s) and control information related to the determined control content(s). The transmission control device 10 transmits the signal to the relay devices 80a to 80d; and the relay devices 80a to 80d control the load(s), to which the address(es) corresponding to the address information is assigned, based on the control information included in the signal.

Similarly, when the operation buttons of the analog switches 90a to 90d or the operation keys of the touch switch 100 are manipulated, a load(s) corresponding to the manipulated operation buttons or keys and control information of the load(s) are determined and a signal having address information of the load(s) and the control information is transmitted to the relay devices 80a to 80d, to thereby control the load(s). This is a brief description related to the remote monitoring and control device 1.

Next, the touch switch 100 will be described as an example of the monitoring and control device.

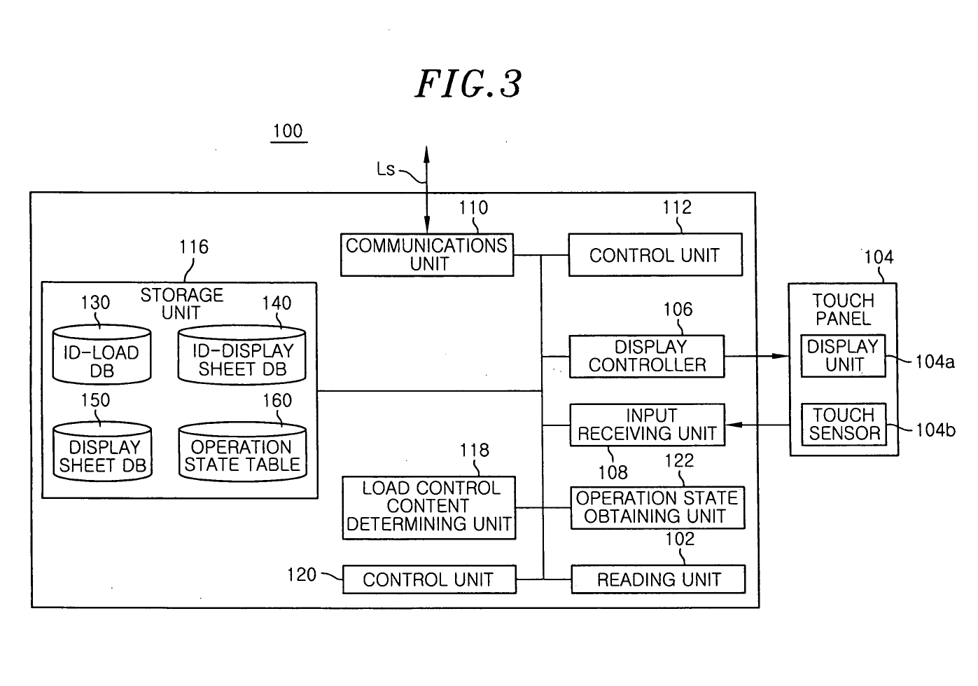

As shown in FIG. 3, the touch switch 100 includes a reading unit 102, a touch panel 104, a display controller 106, an input receiving unit 108, a communications unit 110, a control unit 112, a storage unit 116, a load control content determining unit 118, a display sheet determining unit 120 and an operation state obtaining unit 122.

Since a relatively large power is needed to drive the touch switch 100, the touch switch 100 uses an AC power of 24 V supplied from a remote-control transformer 101 that reduces an AC voltage (e.g., about 100 V) of a commercial power source 8 (referring to FIG. 1).

The reading unit 102 reads out a user ID from the tag 300 or the IC card 400 (referring to FIG. 1). The communication distance of the tag 300 is, e.g., several meters. The IC card 400 is a non-contact IC card and has the communication distance of, e.g., several centimeters.

The touch panel 104 includes a display unit 104a and a transparent touch sensor 104b provided on a screen of the display unit 104a. The display unit 104a is of a liquid crystal type, for example, and displays a variety of information on the screen of, e.g., 3.5 inches. The touch sensor 104b is of a resistive type, for example, and detects a touched position on the screen.

The display controller 106 controls the display unit 104a of the touch panel 104 to display information on the screen. Moreover, if the touch sensor 104b of the touch panel 104 detects a touched position, the input receiving unit 108 receives an input of display contents (operation keys or the like) at the touched position, displayed by the display unit 104a.

The communications unit 110 receives a transmission signal transferred from the transmission control device 10 and transmits a variety of information (signals) to the transmission control device 10 by using a signal-return period of the transmission signal.

The control unit 112 includes a central processing unit (CPU) for executing a control program, a read-only memory (ROM) for storing the control program and a random-access memory (RAM) serving as an operation area, to control various units of the touch switch 100.

The storage unit 116 is formed of, e.g., a flash memory capable of over-writing data and stores an identifier (ID)-load database (DB) 130, an ID-display sheet database 140, a display sheet database 150 and an operation state table 160. These databases 130, 140 and 150 and the table 160 will be described in detail later.

The load control content determining unit 118 refers to (searches) the ID-load database 130 and determines a load(s) corresponding to a user ID that is read out by the reading unit 102 and a control content(s) of the load(s), based on the read-out user ID. Information related to the determined load and the determined control content of the load is transmitted to the relay devices 80a to 80d via the transmission control device 10 by the communications unit 110.

The display sheet determining unit 120 refers to the ID-display sheet database 140 and, based on a user ID that is read out by the reading unit 102, determines a display sheet corresponding to the user ID from a plurality of display sheets of the ID-display sheet database 140. The control unit 106 reads out information corresponding to the determined display sheet from the display sheet database 150 and display the information on the display unit 104a of the touch panel 104.

The operation state obtaining unit 122 obtains an operation state from the operation state table 160. The operation state is displayed on the screen under the control of the display controller 106. For example, the background color of operation keys for turning on loads is displayed darker than that of operation keys for turning off loads so that a user can easily recognize an operation state weather the load is on or off.

Each of the load control content determining unit 118, the display sheet determining unit 120, the operation state obtaining unit 122 and the like includes, e.g., a control program stored in the ROM and a CPU for executing the control program.

In the operation state table 160, the operation state is updated by the control unit (operation state renewing unit) 112 based on a transmission signal having information indicating the operation state (ON/OFF state and the like) of each of the loads L1 to L15, which is regularly received by the communications unit 110.

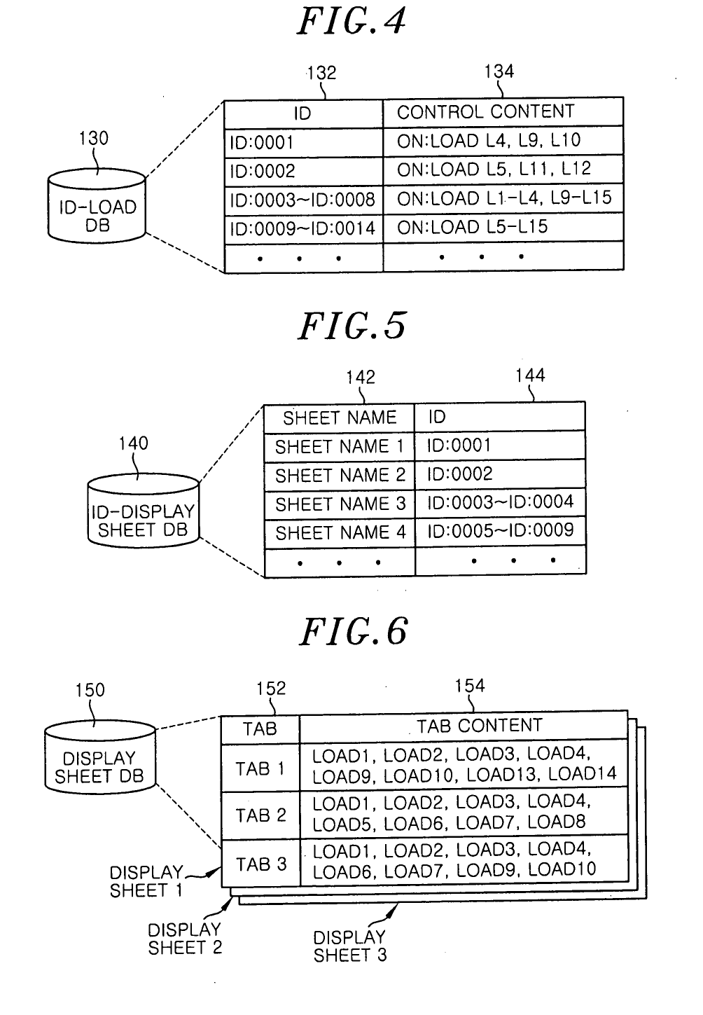

FIG. 4 shows a data configuration of the ID-load database 130. The ID-load database 130 includes an ID item 132 indicating “ID” and a control content item 134 having information for identifying loads corresponding to each user ID of the ID 132 and a control content of the loads. For example, as shown in FIG. 4, a user ID “ID:0001” corresponds to the loads L4, L9, and L10, and the control content thereof indicates that the control content thereof indicates that all the operation states of the loads are ON.

FIG. 5 shows a data configuration of the ID-display sheet database 140. The ID-display sheet database 140 includes a sheet name item 142 identifying a display sheet and an ID item 144 indicating “ID.” Each display sheet has an ID range. For example, “DISPLAY SHEET 1” has one ID “ID:0001,” and “DISPLAY SHEET 4” has five IDs of “ID:0005” to “ID:0009.”

FIG. 6 shows a data configuration of the display sheet database 150.

Each display sheet is of a typical tab type and is configured such that one tab is selected (active) from a plurality of tabs for the display sheets to display a content of the selected (active) tab. For example, three tabs are displayed, and each of the tabs includes eight operation keys for the loads at the maximum. Accordingly, each of the display sheets includes 24 (8×3=24) operation keys at the maximum. Here, the number (three) of the tabs for each display sheet and the number (eight) of the operation keys per tab are merely an example, but the present invention is not limited thereto.

The display sheet database 150 is a database for defining a content of a relative display sheet and includes a tab item 152 and a tab content item 154 indicating loads corresponding to each tab of the tab item 152. In the meantime, the contents of the ID-load database 130, the ID-display sheet database 140 and the display sheet database 150 are registered in advance by, e.g., a manager of the remote monitoring and control system 1.

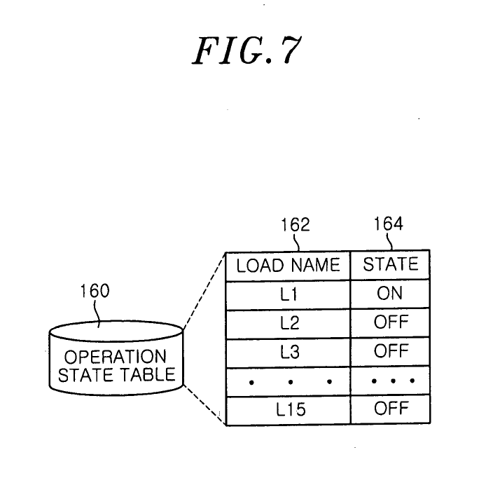

FIG. 7 shows a data configuration of the operation state table 160. The operation state table 160 is a table indicating whether each of the loads L1 to L15 is ON or OFF and includes a load name item 162 and a state item 164. As described above, the communications unit 110 receives the transmission signal having the information indicating the operation state of each of the loads L1 to L15, and the contents of the operation state table 160 is updated based on the transmission signal by the control unit 112.

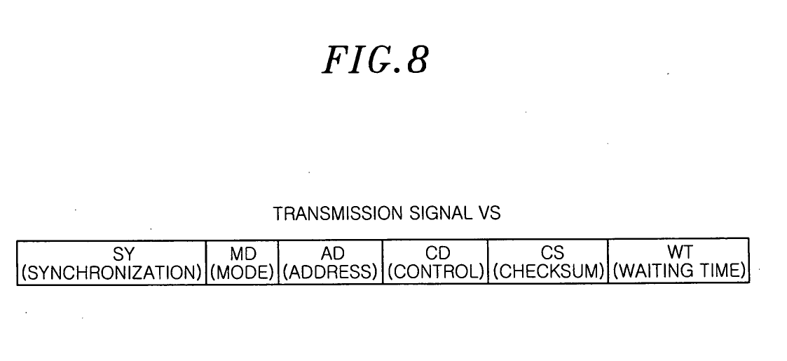

The transmission control device 10 controls the transmission of signals between various units of the remote monitoring and control system 1 and transmits a transmission signal Vs to the units. The transmission signal has a format shown in FIG. 8 including a synchronization (SY) signal SY for indicating the start of signal transmission; mode data MD for indicating a mode type (a control mode, a dummy mode or a monitoring mode) of the transmission signal; address data; control data CD for controlling the load L1 to L15; checksum data CS for detecting an transmission error; a signal-return period (waiting time) data WT serving as a time slot that receives return signals from the relay devices 80a to 80d, analog switches 90a to 90d and the touch switch 100. As for the return signal, a bipolar pulse width modification (PWM) signal of ±24 V is employed.

Since a device for performing the communications by using the transmission signal is basically identical to that of JP10-243478A1, such device will briefly be described with the following patterns 1 to 3.

1. In case that data is transmitted from the transmission control device 10 to one of the relay devices 80a to 80d, the analog switches 90a to 90d, the touch switch 100 and the like, a communications unit (not shown) of the transmission control device 10 transmits a transmission signal including the mode data MD of control mode; and the address data AD having one of the addresses that are respectively assigned to the units. A unit corresponding to the address data AD receives the transmission signal and performs the control based on the control data CD included in the transmission signal.

Specifically, in case that the transmission control device 10 receives information related to a load and a control content of the load from the communications unit 110 of the touch switch 100, the transmission control device 10 transmits a transmission signal including the mode data MD of control mode; the address data AD having an address of the load, included in the received information; and the control data CD having the control content, included in the received information.

2. The communications unit (not shown) of the transmission control device 10 transmits a transmission signal including the mode data MD of dummy mode on a regular basis (e.g., several hundreds of milliseconds). By using the transmission signal, each of the relay devices 80a to 80d, the analog switches 90a to 90d, the touch switch 100 and the like can transmit data during the signal-return period WT of the transmission signal.

3. In case that the transmission control device 10 obtains an operation state of one of the loads L1 to L15, the communications unit (not shown) of the transmission control device 10 transmits a transmission signal including the address data AD having an address of a target load; and the mode data MD of monitoring mode to a relay device (e.g., the relay device 80a for controlling the loads L1 to L4) for controlling the target load corresponding to the address of the transmission signal. Then, the relay device 80a transmits information having the operation state of the target load during the signal-return period WT of the transmission signal.

The obtained operation state of the target load is regularly transmitted from the transmission control device 10 to the touch switch 100 and reflected to the operation state table 160 of the touch switch 100 as described above.

Each of the relay devices 80a to 80d is an example of a load control device and controls ON/OFF of the power switches of the corresponding loads by using an electromagnet. One relay device can be connected to four power switches of loads at the maximum.

The analog switches 90a to 90d are typical switches installed on the wall surfaces. For example, the analog switch 90a includes four operation buttons (operation switches) for controlling the loads L1 to L4 to be turned on and off. Each of the four operation buttons include a green light-emitting diodes (LED) that is turned on when a corresponding load is turned off, a red LED that is turned on when a corresponding load is turned on, and/or the like.

For example, if the operation switch for controlling the load L1 is ON in the analog switch 90a, a transmission signal indicating the load L1 as a target load and having the control content for controlling the load L1 to be turning on is transmitted from the analog switch 90a to the relay device 80a via the transmission control device 10. Then, the power switch of the load L1 is turned on by the relay device 80a to turn on the load L1.

Next, the process of the touch switch 100 will be described.

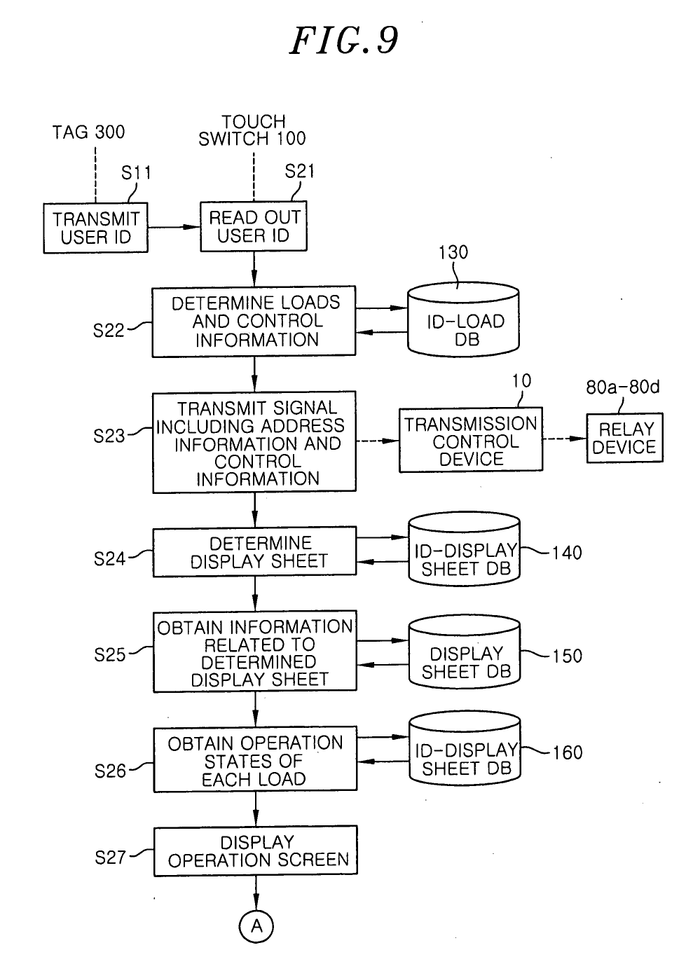

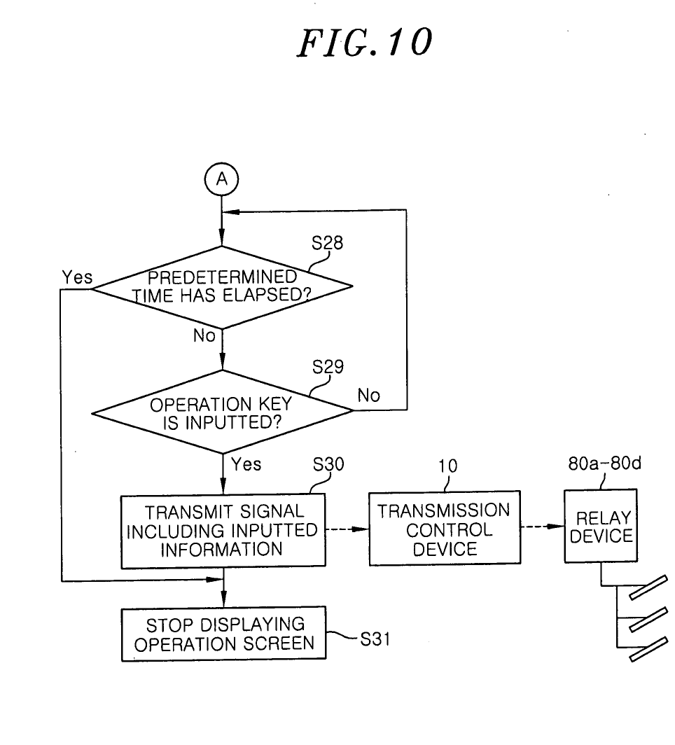

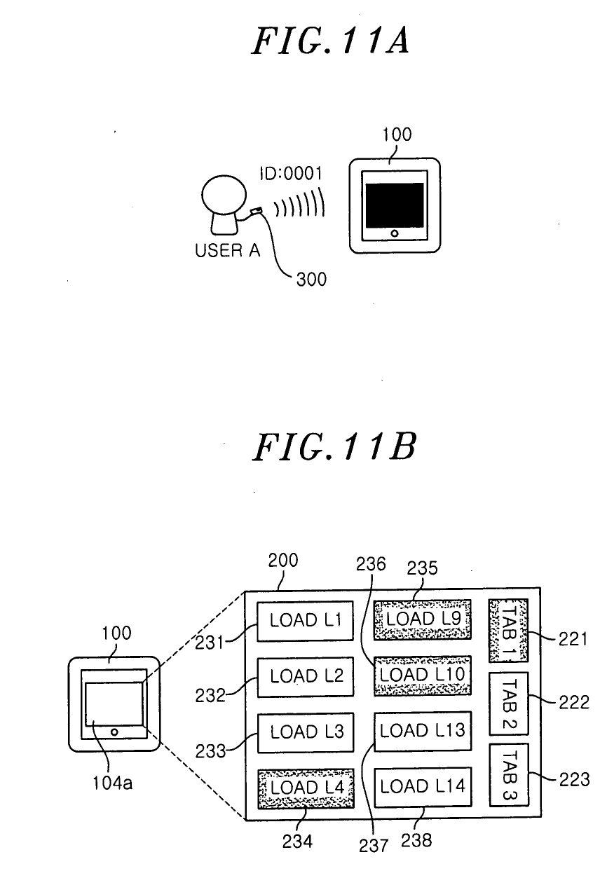

FIGS. 9 and 10 are a flowchart showing the process of the touch switch 100. First, if a user ID from the tag 300 is transmitted to the touch switch 100 (S11), the reading unit 102 of the touch switch 100 reads out the user ID (S21). FIG. 11A shows that the touch switch 100 reads out the user ID from the tag 300 in steps S11 and S21.

The load control content determining unit 118 determines the load(s) corresponding to the read-out user ID and control information thereof (S22) and transmits a signal having address information of the determined load(s) and the determined control information to the transmission control device 10 (S23). The signal is transmitted as a transmission signal from the transmission control device 10 to the relay devices 80a to 80d. A target load(s) corresponding to the address information is controlled based on the control information by the relay devices 80a to 80d.

For example, if a user ID “ID:0001” is read out in step S21, a signal including the address data AD of the loads L4, L9 and L10; and the control data CD having control information that the loads L4, L9 and L10 are turned on is transmitted to the transmission control device 10. The signal is transmitted as a transmission signal from the transmission control device 10 to the relay devices 80a to 80d. The relay device 80a corresponding to the load L4 and the relay device 80c corresponding to the loads L9 and L10 respectively control the load L4 and the loads L9 and L10 to be turned on based on the control information.

The display sheet determining unit 120 determines a target display sheet corresponding to the read-out user ID by referring to the ID-display sheet database 140 (S24) and obtains (reads out) information related to the determined display sheet from the display sheet database 150 (S25). For example, in the case of the user ID “ID:0001,” the display sheet determining unit 120 determines “DISPLAY SHEET 1” as the target display sheet in step S24 and obtains information related to the “DISPLAY SHEET 1” in step S25.

The operation state obtaining unit 122 obtains operation states of the loads L1 to L15 by referring to the operation state table 160 (S26). In step S23, the loads L4, L9 and L10 have already been turned on and, thus, the operation states of the loads L4, L9 and L10 become ON.

Based on the information related to the display sheet obtained in step S25, the display controller 106 turns on a backlight unit of the display unit 104a to display the operation screen (S27). Further, the operation states of the loads displayed on the operation screen are also displayed based on the operation states obtained in step S26.

A detailed example of an operation screen 200 is shown in FIG. 11B. On the operation screen 200, eight operation keys 231 to 238 for the loads L1 to L4, L9, L10, L13 and L14, respectively, are displayed. The operation keys 231 to 238 belong to the “DISPLAY SHEET 1” corresponding to “ID:0001.” Moreover, the three operation keys 234 to 236 respectively indicating that the operation states of the loads L4, L9 and L10 are ON can be easily recognized by a user A by setting a background color of the operation keys 231 to 234 as a deep gray color. Further, there are displayed at a right side of the operation screen 200, a “TAB 1” 221, a “TAB 2” 222, and a “TAB 3” 223 as tab keys for changing the operation keys displayed.

If the input receiving unit 108 receives inputs of the operation keys 231 to 238 while the operation screen 200 is displayed (S29: Yes), the communications unit 110 transmits to the transmission signal device 10 a signal having contents of the inputs (having address information of the loads corresponding to the operation keys and control content information of ON/OFF) (S30).

Moreover, if the input receiving unit 108 receives an input of the “TAB 1” 221, the “TAB 2” 222 or the “TAB 3” 223, the display controller 106 changes operation keys based on the contents of the TABs 221 to 223 by referring to the information of the “DISPLAY SHEET 1” of the display sheet database 150.

If a predetermined time (e.g., 15 sec.) has elapsed since the displaying of the operation screen 200 without receiving an input (S29: No, S28: Yes), the display controller 106 turns off the backlight unit of the display unit 104a to stop displaying the screen (S31).

In accordance with the present embodiment, as described above, since the transmission signal including address information of the loads corresponding to the user ID and control content information of the loads is transmitted (S22, S23), the user A merely allows the touch switch 100 to read out the user ID “ID:0001” of the tag 300 of the user A to turn on the loads L4, L9 and L10 that are frequently used by the user A. In other words, it is possible to turn on the loads L4, L9 and L10 by merely reading out the user ID without conventionally manipulating the operation buttons of the touch switch 100 or analog switches 90a and 90c.

Moreover, as shown in 11B, it is possible to display the “DISPLAY SHEET 1” corresponding to the user ID “ID:0001” as the operation screen 200 of the touch switch 100. For example, with respect to the user A having the tag 300 of the user ID “ID:0001,” if loads that are frequently used by the user A are registered in advance to the “DISPLAY SHEET 1”, it is possible to display an operation screen customized by the user A, thereby improving the operation environment for the user A.

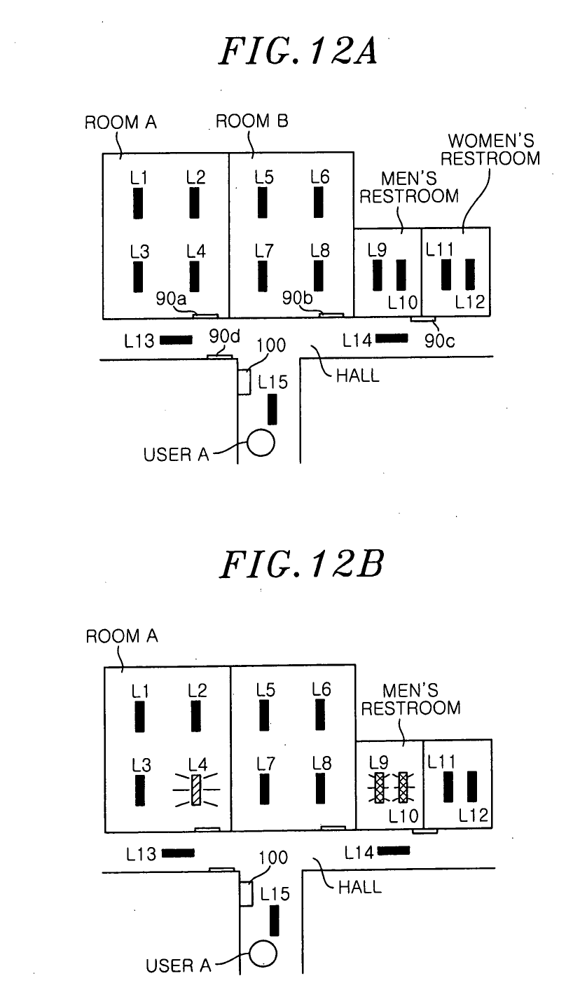

FIGS. 12A and 12B are floor views before and after the user ID “ID:0001” is read out by the touch switch 100. In FIG. 12B, the loads L4, L9 and L10 turned on by the reading-out are shown by hatching.

Until now, the first embodiment of the present invention has been described, but the present invention is not limited to the first embodiment. Various other embodiments may be made to achieve the main and the subsidiary objects of the present invention. For example, the following modifications may be made.

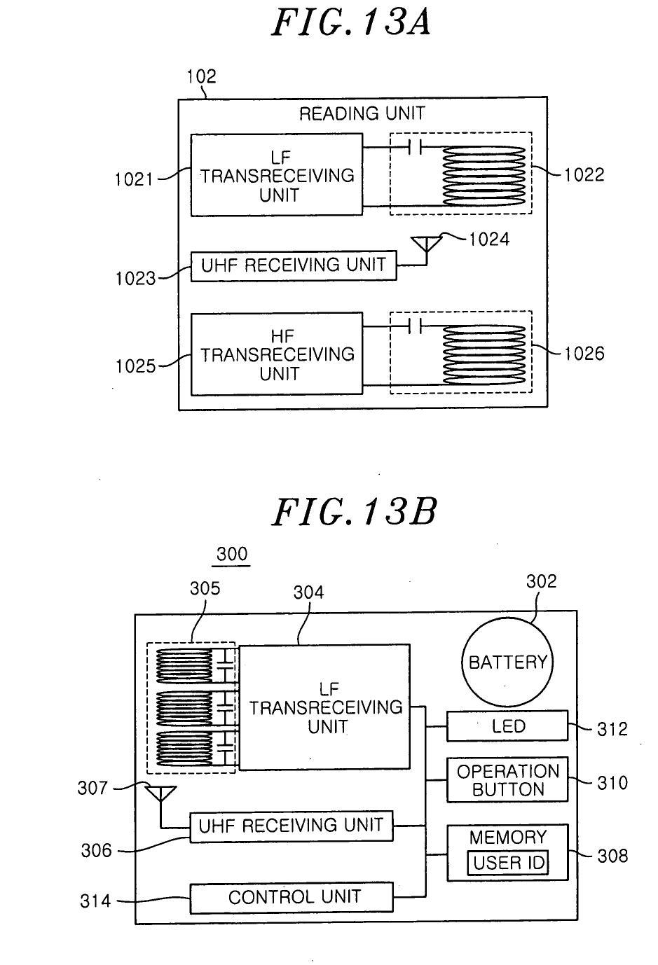

1. The configurations of the tag 300 and the reading unit 102 of the touch switch 100 will be described hereinafter. FIG. 13A is a block diagram showing the reading unit 102 of the touch switch 100. The reading unit 102 includes a low frequency (LF) transreceiving unit 1021, an ultra-high frequency (UHF) receiving unit 1023 and a high frequency (HF) transreceiving unit 1025.

The LF transreceiving unit 1021 regularly transmits an inquiry signal by using an antenna 1022 and receives a response signal including a user ID from the tag 300 that receives the inquiry signal. From a view point for saving the energy, a human body sensor (not shown) may be installed at the reading unit 102 such that the LF transreceiving unit 1021 transmits the inquiry signal only when the human body sensor detects the presence of a human body.

Moreover, in case that a battery 302 of the tag 300 is used up, the LF transreceiving unit 1021 induces a power of the tag 300 by an LF signal such that the tag 300 transmits the response signal thereto by using the induced power.

The UHF receiving unit 1023 receives an UHF signal including a user ID from the tag 300 by using an antenna 1024.

The HF transreceiving unit 1025 performs a proximity non-contact communications with the IC card 400 instead of the communications with the tag 300. Specifically, the HF transreceiving unit 1025 supplies (induces) a power to the IC card positioned near the touch switch 100 by the electromagnetic induction by using an antenna 1026. The IC card 400 transmits its user ID to the HF transreceiving unit 1025 through its antenna (not shown), and the HF transreceiving unit 1025 receives the user ID by using the antenna 1026.

As shown in FIG. 13B, the tag 300 includes the battery 302, an LF transreceiving unit 304, an UHF transreceiving unit 306, a memory 308, an operation button 310, a light emitting diode (LED) 312, and a control unit 314. The battery 302 is a coin-type lithium battery and supplies a power to various units of the tag 300.

The LF transreceiving unit 304 includes an antenna 305 and, if receiving an inquiry signal from the reading unit 102, converts a standby mode to an operation mode. After the operation, the LF transreceiving unit 304 transmits a response signal including a user ID stored in the memory 308 during a predetermined period of time.

The UHF transreceiving unit 306 includes an antenna 307 and transmits an UHF signal including a user ID as the operation button 310 is pushed down.

2. In the above-mentioned embodiment, although the lighting device is taken as an example of the load, the load is not limited thereto. Any electric device capable of being controlled by an electric signal may be employed as the load. Further, although the control content has two values of “ON” and “OFF,” a lighting ratio (e.g., 0 to 100%) may be included in the control content in the case of the lighting device capable of dimming the light.

Besides, in the case of an air conditioner, the control content may include mode setting values of cooling, heating and dehumidifying, temperature setting values and the like in addition to the values of “ON” and “OFF.”

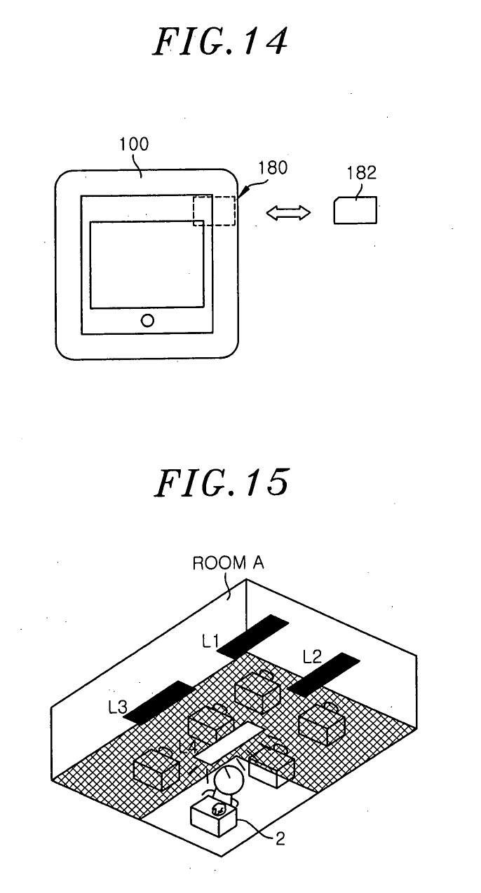

3. The storage unit 116 of the touch switch 100 may be provided outside a housing of the touch switch 100. For example, as shown in FIG. 14, a slot 180 for a SD memory card may be provided at the housing of the touch switch 100, and a SD memory card 182 storing the databases 130 to 150 and the like may be releasably included in the slot 180. Furthermore, since a SD memory card is widely used, a typical personal computer may have a slot. Accordingly, a user can input information such as the databases 130 to 150 into the SD memory by using a personal computer in advance and use the inputted information in the touch switch.

Further, although the databases 130 to 150 and the table 160 are stored in the storage unit 116 of the touch switch 100 in the above-mentioned embodiment, they may be stored in an external storage device instead.

4. In the above-mentioned embodiment, the information is transmitted and received between the units of the remote monitoring and control system 1 through the transmission control device 10. However, it is not necessary to interpose the transmission control device 10. For example, by employing a typical communications method (e.g., RS-485 communications or the like), a signal or the like including address information of a target load and a control content of the load may be directly transmitted and received between the touch screen and the relay devices.

5. In the above-mentioned embodiment, the load operation keys 231 to 238 displayed on the operation screen 200 (referring to FIG. 11B) one-to-one correspond to the loads. However, one operation key may correspond to, e.g., the loads L1 and L2 to turn on and off the loads L1 and L2 together. Such method for controlling a plurality of loads together is referred to as a group control method.

Moreover, one operation key may correspond to the loads L1 to L4 to turn on the loads L1 and L4 and turn off the loads L2 and L3 to embody the pattern lighting of the room A. Such method for controlling the loads based on a predetermined pattern is referred to as a pattern control method.

6. As shown in FIG. 15, the load L4 installed at the ceiling above a desk 2 that is usually used by the user A is preferably turned on at all times, but the loads L9 and L10 installed at the ceiling of the men's restroom are less necessarily turned on at all times. For that reason, the loads L9 and L10 may preferably be converted into a sensor standby mode instead of being turned on. In the sensor standby mode, as a human body comes close to the loads L9 and L10, the loads L9 and L10 are turned on.

In the sensor standby mode, as shown in FIG. 16, an infrared sensor 3 for detecting whether or not there is an object depending on whether or not an infrared ray is blocked is provided at an entrance of the men's restroom. When the infrared sensor detects that there is an object (human body), the loads L9 and L10 are turned on during a specific period of time. Accordingly, it is possible to reduce a power waste.

7. In the aforementioned embodiment, as shown in FIG. 11B, the operation screen 200 including the operation keys 231 to 238 corresponding to the user ID “ID:0001” of the user A is displayed. However, from the point of view for providing a user-customized operation screen, it is sufficient to control the loads depending on each user ID, but it is not necessary to display the operation screen for each of the user IDs. In other words, in FIG. 9, an operation screen displayed in step S27 after steps S24 and S25 and the like are skipped may be common to all the user IDs.

Meanwhile, as for the loads (e.g., L4, L9 and L10) that have already been controlled for each of the user IDs, a user may want to see or change their operation states. Accordingly, the operation screen displayed in step S27 preferably includes the operation keys for operating the already-controlled loads L4, L9 and L10.

8. In the above-mentioned embodiment, as shown in FIG. 4, one user ID corresponds to one kind of combination of three loads L4, L9 and L10, but the present invention is not limited thereto. One user ID may correspond to a plurality of kinds of combinations to be changed depending on time zones. For example, one user ID “ID:0001” may correspond to the loads L4, L9 and L10 as described above at day and more loads L1 to L4, L9, L10, and L13 to L15 at night. In this way, it is possible to turn on all the loads in the room A or the hall at night.

9. Although the touch sensor 104b of the touch panel 104 is taken as an example of an input unit in the above-mentioned embodiment, various input devices such as a keyboard, a mouse and the like may be employed as the input unit without the restriction to the touch sensor 104b.

10. In the aforementioned embodiment, based on the ID-load database 130, the loads corresponding to the user ID of the user A are controlled by transmitting the signal including address information of the loads and the control content to the relay devices 80a to 80d. However, to display the user-customized operation screen, it is not necessary to automatically control the loads for each of the user IDs. In other words, in FIG. 9, steps S22 and S23 and the like may be skipped.

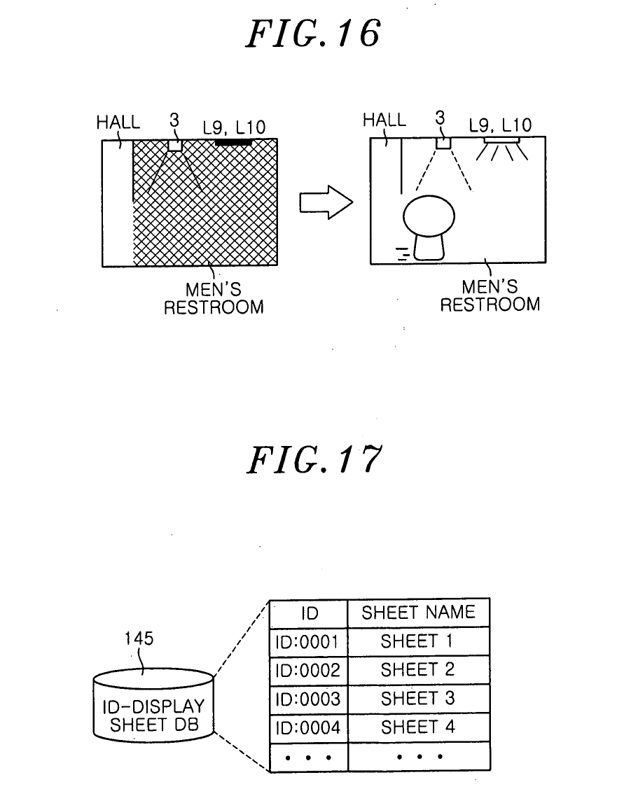

11. In the above-mentioned embodiment, the ID-display sheet database 140 (FIG. 5) has the data configuration in which each display sheet corresponds to the corresponding ID range, but the present invention is not limited thereto. In an ID-display sheet database 145 shown in FIG. 17, each display sheet may correspond to each ID.

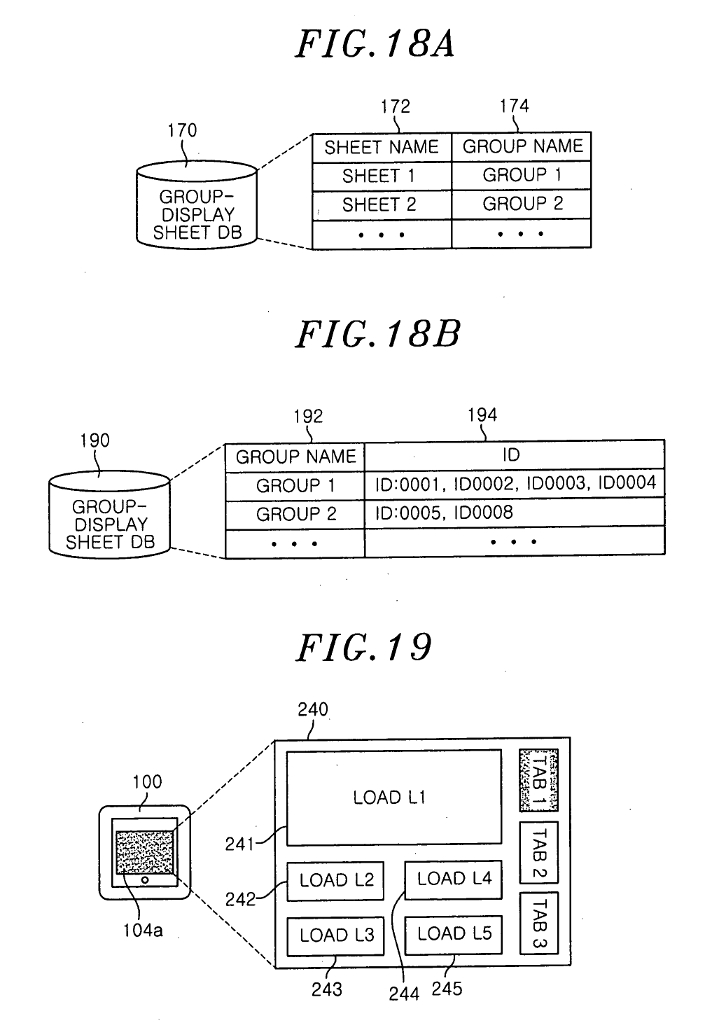

Moreover, as shown in FIGS. 18A and 18B, the storage unit 116 may store both a group-display sheet database 170 in which a sheet name item 172 corresponds to a group name item 174; and a group-ID database 190 in which a group name item 194 corresponds to an ID item 194, and the display sheet determining unit 120 may specially determine a display sheet name corresponding to an user ID that is read out by referring to the databases 170 and 190.

12. In the abovementioned embodiment, as shown in FIG. 6, the display sheet database 150 has the data configuration including three tabs and eight operation keys for each of the tabs, but the present invention is not limited thereto. The data configuration may include any components for a graphical user interface (GUI) serving as an operation screen. For example, the data configuration may include components such as the number of the tabs for the display sheet, the number of the operation keys for each of the tabs, position and size of each of the operation keys, character settings (font type, font size, font design and the like) of each of the operation keys and background color of each of the operation keys.

By providing the components as the contents of the display sheet database 150, it is possible to display the display sheet for each of the user IDs. For example, in an operation sheet shown in FIG. 19, the size of an operation key 241 for the load L1 becomes increased as compared with those of operation keys 242 to 245 for the respective loads L2 to L5 by setting the size of the operation key 241 to, e.g., 50×20 and the size of the remaining operation keys 242 to 245 to, e.g., 22×10.

13. In the aforementioned embodiment, as shown in FIG. 11B, the “TAB 1” is active from the “TAB 1” to the “TAB 3”. However, the active TABs may be changed depending on, e.g., time zones and the days of the week. For example, the “TAB 1”, the “TAB 2” and the “TAB 3” may be pre-set for day (8 o'clock to 17 o'clock) on a weekday, night (17 o'clock to 8 o'clock) on a weekday and the weekend (Saturday and Sunday) to display the operation sheets of the active tabs depending on the time zone and the day of the week when the user ID is read out.

If the operation states of the loads L1 to L15 are different depending on the day and the night, and the weekday and the weekend, it is possible to display a user-customized operation screen by changing the tabs depending on the time zones and the days of the week.

### Second Embodiment

Next, a second embodiment of the present invention will be described with reference to the relative drawings.

A remote monitoring and control system 11 of the second embodiment has the configuration similar to that of the system 1 of the first embodiment except for a touch switch 100′. Accordingly, components having substantially the same configuration and function are denoted by like reference characters and, thus, redundant description thereof will be omitted herein.

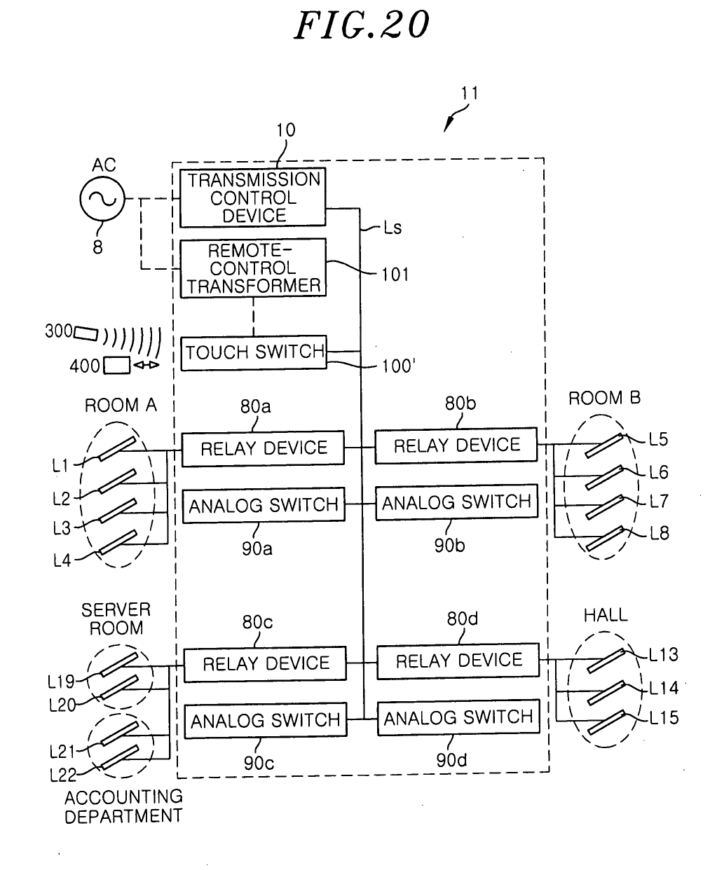

As shown in FIG. 20, in accordance with the present embodiment, the loads L19 and L20 and the loads L21 and L22 are respectively installed in a server room and in an accounting department.

In the present embodiment, once a user ID is read out from the tag 300 of a user, the touch switch 100′ determines whether or not the user ID has the display authority and, if the user ID has the display authority, displays an operation screen for controlling a load(s). Then, if operation keys of the operation screen of the touch switch 100′ are manipulated, the touch switch 100′ determines a load(s) corresponding to the user ID and control information of the load(s). Then, the touch switch 100′ transmits to the transmission control device 10 a signal having address information of the determined load(s) and the determined control information. The transmission control device 10 transmits the signal to the relay devices 80a to 80d; and the relay devices 80a to 80d control a load(s), to which an address(es) corresponding to the address information is assigned, based on the control information included in the signal.

Similarly, when the operation buttons of the analog switches 90a to 90d are manipulated, a load(s) corresponding to the manipulated operation buttons and control information of the load(s) are determined and a signal having address information of the load(s) and the control information is transmitted to the relay device 80a to 80d, to thereby control the load(s). This is a brief description related to the remote monitoring and control device 11.

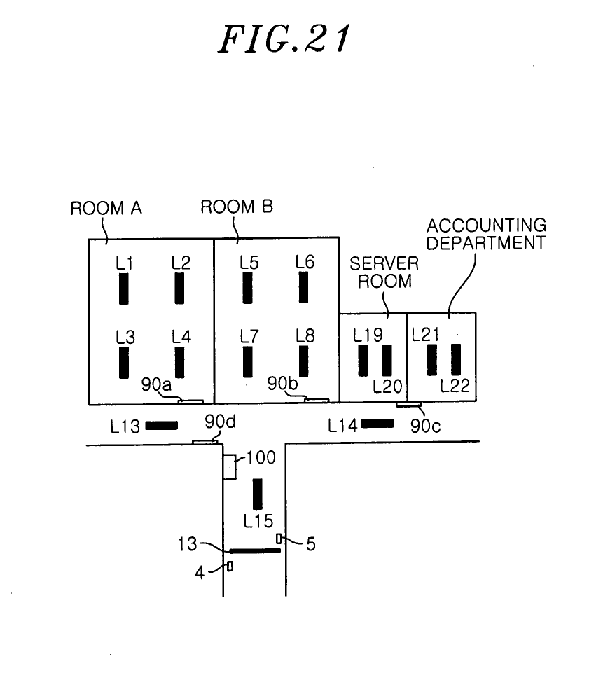

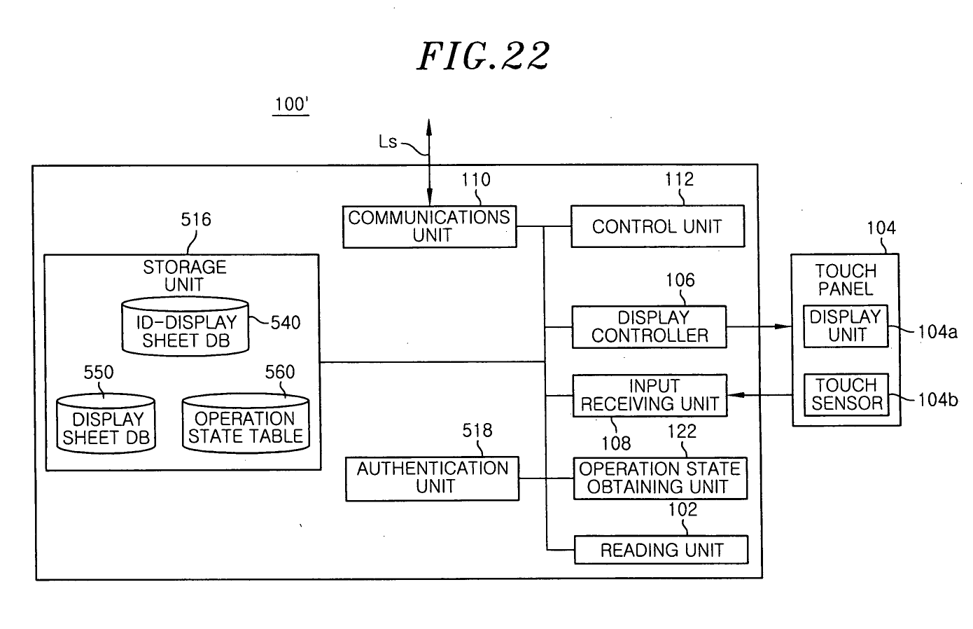

In the meantime, as shown in FIG. 21, a gate 13, an entering authentication device 4 and a leaving authentication device 5 are installed at an entrance of a hall. Both the authentication devices 4 and 5 constitute an entering/leaving management system.

The gate 13 is, e.g., a door with an electric lock, and the electric lock is usually locked to restrict a user to pass through the gate 13. However, once the entering authentication device 4 reads out a user ID from the tag 300 of a user, the entering authentication device 4 determines whether or not the user ID has the passage authority for the gate 13 and, if the user ID has the passage authority, the authentication device 4 permits the user to pass through the gate 13 by releasing the electric lock of the gate 13 during a predetermined period of time (e.g., about 10 sec.).

In the above-mentioned entering/leaving management system, a user can obtain the authentication of the authentication device 4 or 5 by using the tag 300 or the IC card 400 to pass through the gate 13. Meanwhile, even though a user receives no authority, the user may pass through the gate 13 by tailgating another user who has been just permitted to pass through the gate 13 (This is referred to as tailgating passage). Further, the user who does not receive the authority may pass through the gate 13 that is opened when another user passes through the gate 13 in the opposite direction (This is referred to as crossing passage).

The tailgating passage and the crossing passage may cause the security or the accuracy of entering and leaving logs of the entering/leaving management system to be deteriorated. For that reason, a manager of the entering/leaving management system requires the management system to adequately perform the authentication to all users.

Next, various units of the remote monitoring and control system 11 will be described.

The touch switch 100′ will be described as an example of the monitoring and control device.

As shown in FIG. 22, the touch switch 100′ includes the reading unit 102, the touch panel 104, the display controller 106, the input receiving unit 108, the communications unit 110, the control unit 112, the storage unit 116, an authentication unit 518, and the operation state obtaining unit 122.

Similarly to the first embodiment, since a relatively large power is needed to drive the touch switch 100′, the touch switch 100′ uses an AC power of 24 V supplied from the remote-control transformer 101 that reduces an AC voltage (e.g., about 100 V) of a commercial power source 8 (referring to FIG. 20).

The storage unit 516 is formed of, e.g., a flash memory capable of over-writing data and stores an authority database 540, a display sheet database 550 and the operation state table 160. These databases 540 and 550 will be described in detail later. The operation state table 160 has already been described in the first embodiment.

The authentication unit 518 determines whether or not a user ID that is read out by the reading unit 102 has the display authority by comparing the read-out user ID with the authority database 540 indicating whether or not to have the display authority.

The authentication unit 518 includes, e.g., a control program stored in the ROM and a CPU for executing the control program.

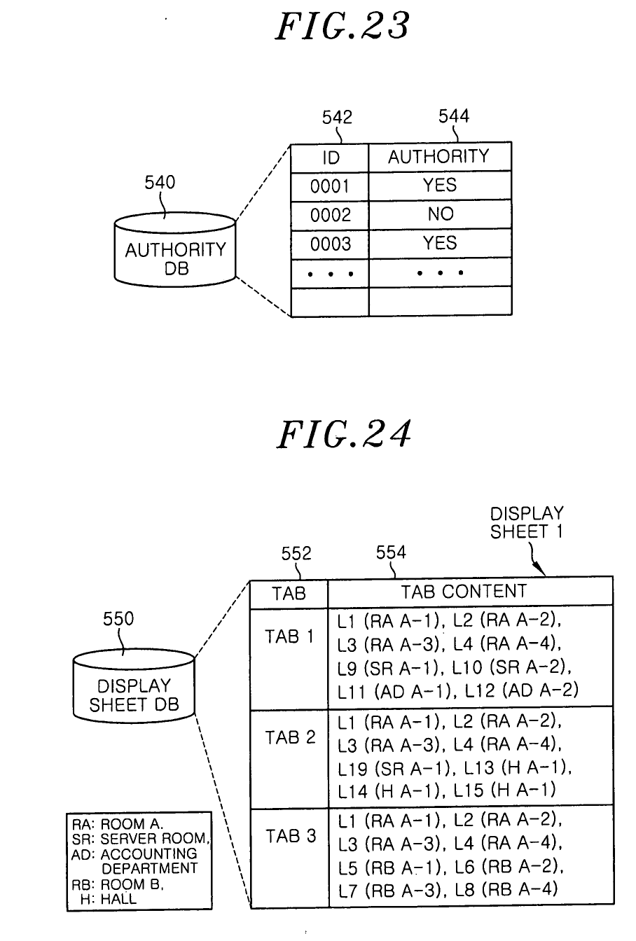

FIG. 23 shows a data configuration of the display sheet database 540. The display sheet database 540 is a database indicating whether each user ID has the display authority of the operation screen and includes an ID item 542 indicating “user ID” and an authority item 544 indicating whether or not each of the user IDs included in the ID item 542 has the authority. For example, as shown in FIG. 23, user IDs “ID:0001” and “ID:0003” have the authority, but a user ID “ID:0002” has no authority.

FIG. 24 shows a data configuration of the display sheet database 550. Similarly to the first embodiment, each display sheet is of a typical tab type and is configured such that one tab is selected (active) from a plurality of tabs for the display sheets to display a content of the selected (active) tab. For example, three tabs are displayed, and each of the tabs includes eight operation keys for the loads at the maximum. Accordingly, each of the display sheets includes 24 (8×3=24) operation keys at the maximum. Here, the number (three) of the tabs for the display sheets and the number (eight) of the operation keys per tab are merely an example, but the present invention is not limited thereto.

The display sheet database 550 is a database for defining a content of a display sheet and includes a tab item 552 and a tab content item 554 indicating loads corresponding to each tab of the tab item 552. “Room A-2” and the like in parentheses are registered by a user. The display controller 106 displays such portions in parentheses as the names of operation keys displayed on the operation screen, so that the user can easily recognize which load each of the operation keys corresponds to.

In the meantime, the contents of the authority database 540 and the display sheet database 550 are registered in advance by, e.g., a manager of the remote monitoring and control system 11.

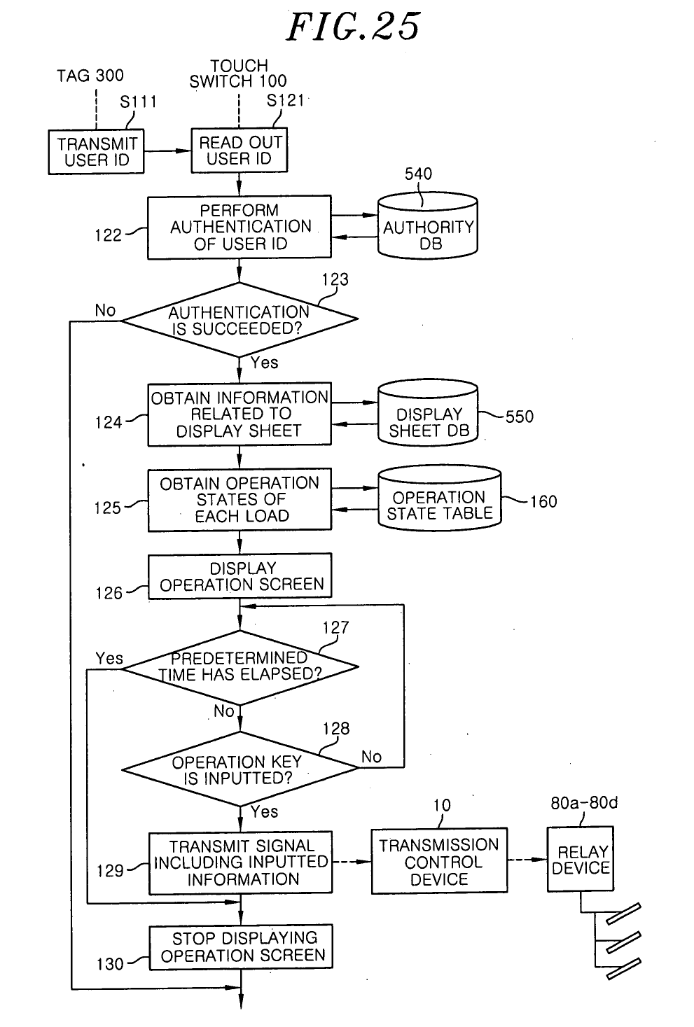

Next, two process examples of the touch switch 100′ in accordance with the second embodiment will be described. FIG. 25 is a flowchart showing the process of the touch switch 100′ in accordance with a first example.

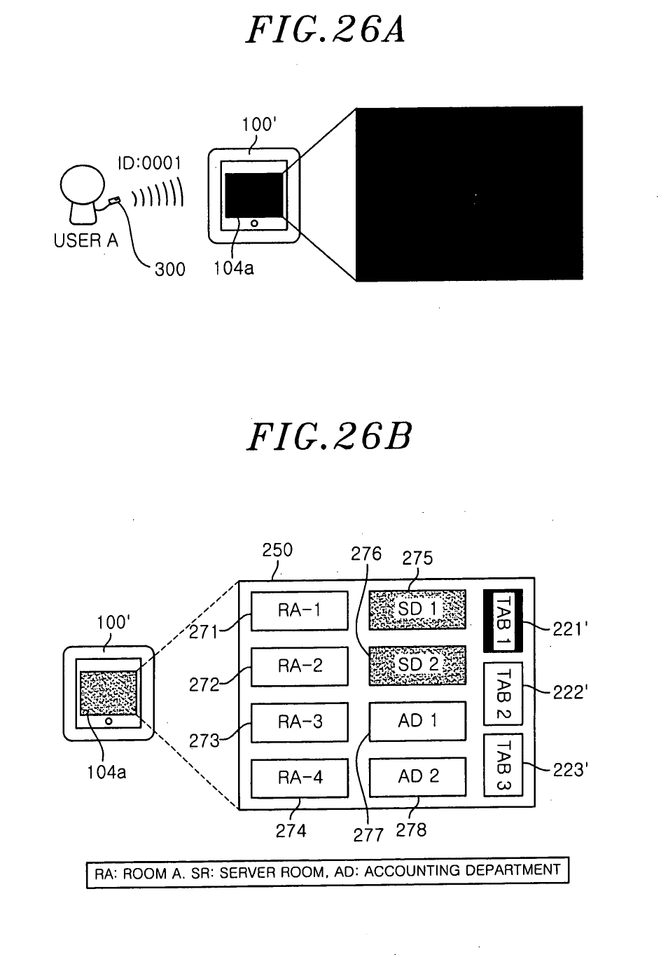

First, if a user ID read out from the tag 300 is transmitted to the touch switch 100′ (S111), the reading unit 102 of the touch switch 100′ reads out the user ID (S121). FIG. 26A shows that the touch screen 100′ reads out the user ID “ID:0001” of the user A. As shown in FIG. 26A, a backlight unit of the display unit 104a is turned off at an initial state (the screen is OFF).

The authentication unit 518 performs the authentication for determining whether or not the read-out user ID has the authority by referring to the authority database 140 (S122). If the authentication is succeeded (S123: Yes), the display controller 106 obtains data of the display sheet database 150 (S124), and the operation state obtaining unit 122 obtains operation state information of the loads L1 to L8, L11 to L13 and L19 to L22 by referring to the operation state table 160 (S125).

Then, the display controller 106 displays an operation screen 250 based on the display sheet data obtained in step 5124 by turning on the backlight unit of the display unit 104a (S126). Further, the operation states of the loads displayed on the display screen 250 are also displayed thereon.

FIG. 26B shows a detailed example of the operation screen 250. As shown in FIG. 26B, the operation screen 250 includes operation keys 271 to 278 for the loads L1 to L4 and L19 to L22, respectively. Names such as “Room A-1” for the loads L1 to L4 and L19 to L22 are respectively displayed on the operation keys 271 to 278 such that the user A can easily recognize which load each of the operation keys corresponds to.

Moreover, the user A can easily recognize two operation keys 275 and 276 respectively indicating that the operation states of the loads L19 (Server room-1) and L20 (Server room-2) are ON by setting a background color of the operation keys 275 and 276 as a deep gray color. Further, at a right side of the operation screen 250, there are displayed “TAB 1” 221′, TAB 2” 222′, and “TAB 3” 223′ as tab keys for changing the operation keys displayed.

If the input receiving unit 108 receives inputs of the operation keys 271 to 278 while the operation screen 250 is displayed (S128: Yes), the communications unit 110 transmits to the transmission signal device 10 a signal having contents of the inputs (having address information of the loads corresponding to the operation keys and control content information of ON/OFF) (S129).

Moreover, if the input receiving unit 108 receives an input of the “TAB 1” 221′, the “TAB 2” 222′ or the “TAB 3” 223′, the display controller 106 changes operation keys based on the contents of the TABs 221′ to 223′ by referring to the information of the “DISPLAY SHEET 1” of the display sheet database 550.

If a predetermined time (e.g., 15 sec.) has elapsed since the displaying of the operation screen 250 without receiving an input (S128: No, S127: Yes), the display controller 106 turns off the backlight unit of the display unit 104a to turn off the displayed screen (S130).

In the meantime, if the authentication is failed by determining that the user ID has no authority by the authentication unit 518 (S123: No), the screen is maintained OFF without performing steps S124 to S130.

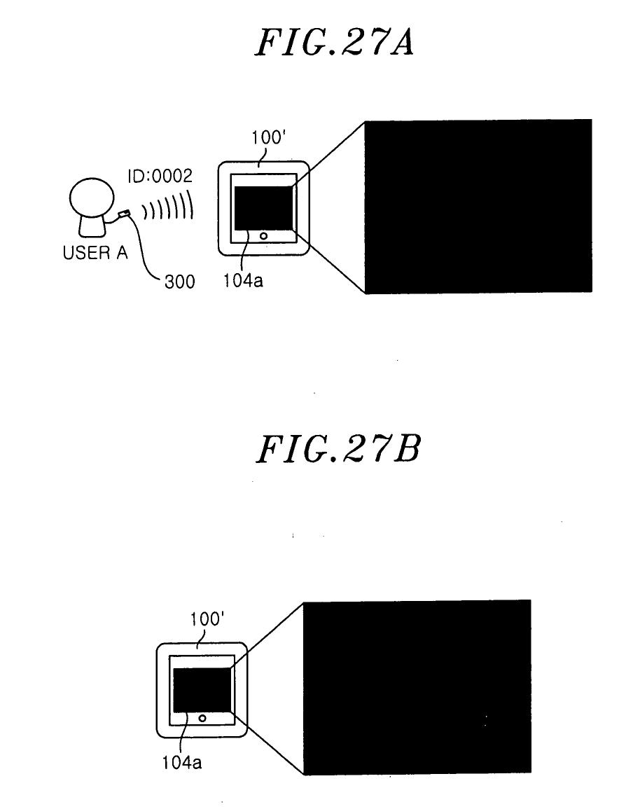

As an example of the case that the authentication is failed, FIGS. 27A and 27B shows the case of a user B carrying a user ID “ID:0002” having no authority.

As described above, in accordance with the present embodiment, the operation screen 250 is displayed after the authentication is succeeded for the user A having the display authority, so that the user A can manipulate the operation screen to control the loads (FIGS. 26A and 26B).

On the other hand, by displaying no operation screen for the user B having no display authority, it is possible to possible to prevent the user B from obtaining any security information and prevent the loads from being controlled inappropriately, thereby saving the energy (FIGS. 27A and 27B).

Further, by displaying the operation states (ON and OFF) of the loads on the operation screen 250, it is possible to improve the user's convenience. However, it is easy to obtain the information that any one exists in the server room but no one exists in the accounting department, which may be ill-intentionally used by a worked user. In accordance with the present embodiment, it is possible to prevent such ill-intentional use by displaying no operation screen for a user having no display authority.

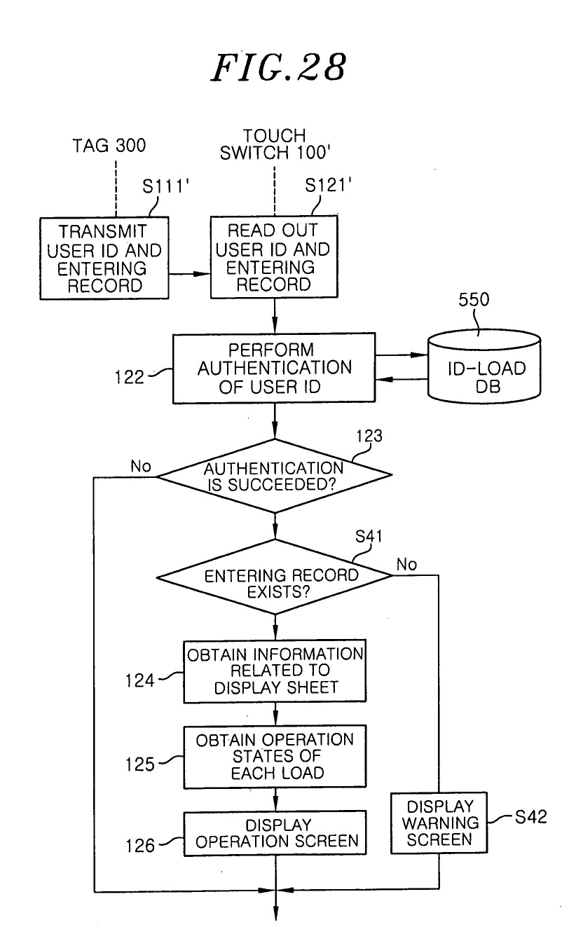

FIG. 28 is a flowchart showing the process of the touch switch 100′ in accordance with a second example. In FIG. 28, the same steps as those of FIG. 25 are given to the same step numerals.

First, if a user ID and its entering record read out from the tag 300 are transmitted to the touch switch 100′ (S111), the reading unit 102 of the touch switch 100′ reads out the user ID and its entering record (S211). The entering record is information stored in the memory of the tag 300 by the entering authentication device 4 when the authentication is succeeded. The entering record is stored in, e.g., “0” or “1.” For example, the entering authentication device 4 writes “1” (0→1) and the leaving authentication device 5 writes “0” (1→0). The value of the entering record normally is “1” during the entering and “0” after the leaving.

If the authentication for displaying the operation screen is succeeded by the read-out user ID (S122, S123: Yes), the authentication unit 518 checks which value the entering record has (S41). If the entering record has “1” (S41: Yes), the operation screen is displayed by obtaining the display sheet data (S124) and the operation state information(S125), similarly to the first example shown in FIG. 25. On the other hand, if the entering record has “0,” that is, no entering record exists (S41: No), the display controller 106 displays a warning screen 270 (S42).

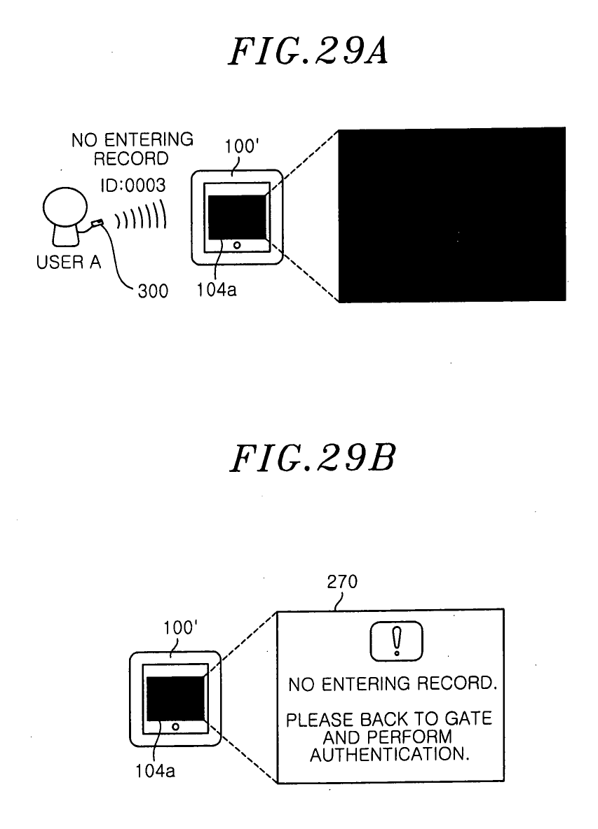

FIGS. 29A and 29B show an example of the warning screen 270. Specifically, FIG. 29A shows the touch switch 100′ reads a user ID “ID:0003” from the tag 300 of a user C. Even though the user C has the authority for displaying the operation screen, the user C passes through the gate 13 through the tailgating passage or the cross passage without performing the authentication and, thus, the entering record stored in the tag 300 of the user C has “0.” FIG. 29B shows the warning screen 270 displayed to the user C. On the warning screen 270, report messages “No entering record” and an urging message “Please back to the gate and perform the authentication” are displayed.

By displaying the warning screen 270, it is possible to urge the user C to perform the authentication (it is thought that the user C is highly likely to follow the urging message since the user C is not able to control a desired load(s)). That is, when each user tries to pass through the gate 13, it is possible to urge he/she to unexceptionally perform the authentication, thereby preventing the tailgating passage or the cross passage.

Moreover, it is possible to habituate all users to unexceptionally perform the authentication at the door. Accordingly, the entering/leaving management system can write all logs, thereby improving the security.

In addition, when there is no entering record, the notification may be made to notify the outside that there was an illegal passage in addition to displaying the warning screen 270 (S42).

Specifically, as shown in FIG. 30, the control unit 112 (serving as an illegal passage notifying unit) of the touch switch 100′ transmits notification information for notifying that there was an illegal passage to an entering/leaving management server 502 (constituting an entering/leaving management system 500).

The entering/leaving management server 502, which receives the notification information, may store the notification information as a log to use it in the log analysis in the future or inform a manager of the management system 500 of the illegal passage by using an alarm device (not shown) or an alarm lamp (not shown). In the meantime, such notification may be further made when the authentication is failed (S123 in FIG. 125: No).

Until now, the second embodiment of the present invention has been described, but the present invention is not limited to the second embodiment. Various other embodiments may be made to achieve the main and the subsidiary objects of the present invention. For example, the modifications 1 to 5 in the first embodiment may also be made, and additional modifications may be made as follows.

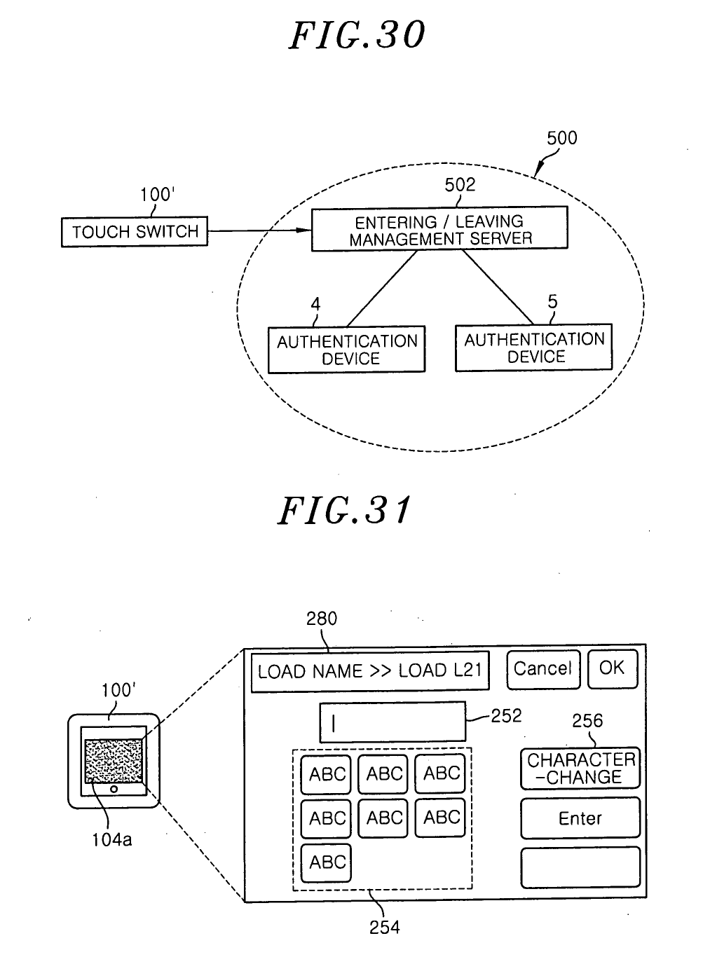

1. The names of the operation keys may be set by the touch switch 100′. FIG. 31 shows the case that the names of the operation keys are set by the touch switch 100′. In the touch switch 100′, a setting screen 280 for setting the names of operation keys is displayed. The setting screen 280 includes a window 252 for inputting a name of each load, an alphabet key group 254, a character-changing key 256 for changing the character types, such as alphabets, hiraganas and numerals, and the like.

2. Although the entering record is simply stored in “0” or “1” in the above-mentioned embodiment, the entering record may include any information capable of determining whether or not the authentication is appropriately performed.

Specifically, gate IDs for identifying the gates and/or the entering date and time may be stored in the entering record. Then, the gate IDs and/or the entering date and time are used as determining factors of step S41. For example, a warning screen may be displayed when no entering record exists with respect to a gate ID for an especially important gate, which requires the reliable authentication, of a plurality of gates or when the entering record has a past date and time (e.g., any time yesterday).

Moreover, in the above-mentioned embodiment, the touch switch 100′ reads out the entering record from the tag 300 (S211 in FIG. 28), but the present invention is not limited thereto. Instead of reading out the entering record from the tag 300, the touch switch 100′ may obtain information of the entering record from the entering/leaving management server 502, which manages entering and leaving records for each of the user IDs and determine whether or not there is the entering record (S41 in FIG. 28) by using the obtained information.

3. In the aforementioned embodiment, the operation screen is not displayed at all to prevent the loads from being controlled when the authentication is failed (S123 in FIG. 25: No) or no entering record exists (S41 in FIG. 28: No). However, the operation screen may be partially displayed.

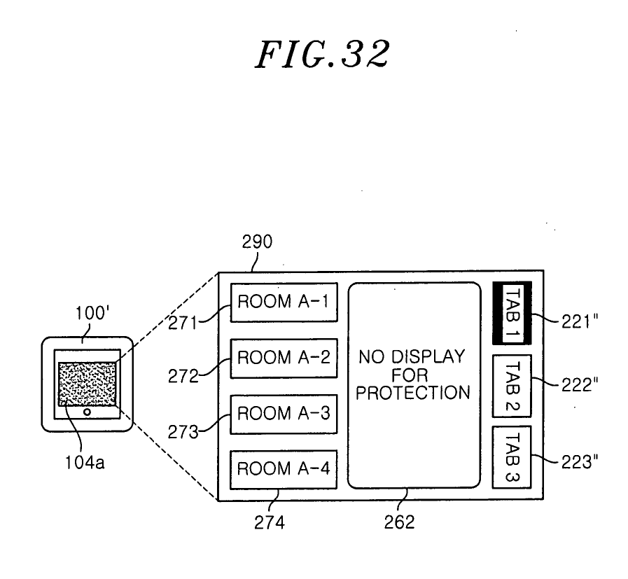

Specifically, the operation keys 271 to 274 are displayed at the left-half side of an operation screen 290 shown in FIG. 32 similarly to those in the operation screen 250 shown in FIG. 26B. On the other hand, the operation keys 275 to 278 expected to be displayed may be covered by a protective sheet 262 at the right-half side of the operation screen 290, so that they are not displayed. Accordingly, by allowing the operation keys 275 to 278 not to be displayed, it is possible to hide the presence of the high-security rooms such as “Server room-1”, “Server room-2”, “Accounting department-1” and “Accounting department-2” and the operation states of the loads therein; and prevent, e.g., ON/OFF control of the loads therein. The operation keys 275 to 278 may be hided by, for example, adding identifying information for determining whether or not to hide some of the loads to the tab content information of the display sheet database 550.

In brief, unlike the aforementioned embodiment where the operation screen is not displayed at all, it is possible to obtain the same effect by partially hiding the operation screen, in terms of adequately controlling whether to display the operation screen depending on the presence or absence of the authority.

4. In the above-mentioned embodiment, the entering authentication device 4 writes the entering record in the tag 300. However, in the case of a unit having no recording medium capable of overwriting data like the IC card 400, the authentication device 4 may write a user ID and a corresponding entering record in the entering/leaving management server 502, when the authentication is performed, so that the touch switch 100′ checks whether or not the read-out user ID has its entering record by asking the entering/leaving management server 502 about the entering record.

While the invention has been shown and described with respect to the embodiments, it will be understood by those skilled in the art that various changes and modifications may be made without departing from the scope of the invention as defined in the following claims.

What is claimed is:

1. A remote monitoring and control system comprising:
a monitoring and control device being operated to control one or more loads; and
a load control device for controlling the loads based on the operation of the monitoring and control device,
wherein the monitoring and control device includes:
a display unit for displaying an operation screen including one or more operation keys for controlling corresponding ones of the loads;
an input receiving unit for receiving an input of the displayed operation keys;
a reading unit for reading out a user ID;
a storage unit for storing load-identifying information identifying loads and control information having control contents of the loads in a corresponding relationship to each user ID; and
a determining unit for searching the storage unit if a user ID is read out by the reading unit, and determining the load-identifying information and the control information which correspond to the read-out user ID, and
the load control device controls the loads identified based on the load-identifying information determined by the determining unit, depending on the control contents of the control information determined by the determining unit.

2. The system of claim 1, wherein the input receiving unit includes a touch sensor, provided on the display unit, for detecting a position touched on the operation screen and, if a touched position is detected by the touch sensor, receives an input of the operation key displayed at the touched position detected by the touch sensor.

3. The system of claim 1, wherein the reading unit reads out the user ID from a tag including a battery, the tag transmitting the user ID by a power supplied from the battery.

4. The system of claim 1, wherein the reading unit includes an antenna and induces a power to a non-contact IC card including another antenna to read out the user ID from the non-contact IC card.

5. A monitoring and control device connected to a load control device for controlling one or more loads and installed separately from the loads, the monitoring and control device comprising:
a display unit for displaying an operation screen including one or more operation keys for controlling corresponding ones of the loads;
a touch sensor, provided on the display unit, for detecting a position touched on the operation screen;
an input receiving unit for receiving an input of an operation key displayed at the touched position detected by the touch sensor;
a reading unit for reading out a user ID;
a storage unit for storing load-identifying information identifying loads and control information having control contents of the loads in a corresponding relationship to each user ID;
a determining unit for searching the storage unit if a user ID is read out by the reading unit and determining the load identifying information and the control information which correspond to the read-out user ID; and
a transmission unit for transmitting to the load control device the load-identifying information and the control information determined by the determining unit.

6. A monitoring and control device used in a remote monitoring and control system including the monitoring and control device and a load control device for controlling one or more loads based on an operation of the monitoring and control device, the monitoring and control device being operated to control the loads, the device comprising:
a display unit for displaying an operation screen including one or more operation keys for controlling corresponding ones of the loads;
a touch sensor, provided on the display unit, for detecting a position touched on an operation screen;
a reading unit for reading out a user ID;
a storage unit for storing user IDs and a plurality of display data used to display the operation screen, the display data respectively corresponding to the user IDs;
a determining unit for determining one of the display data based on the user ID that is read out by the reading unit;
a display controller for displaying the operation screen including the operation keys on the display unit by using the determined display data; and
an input receiving unit for receiving an input of the operation key displayed at the touched position detected by the touch sensor.

7. The device of claim 6, wherein at least one of the display data stored in the storage unit corresponds to at least two of the user IDs.

8. The device of claim 6, wherein the operation screen includes a plurality of tabs, each of which has at least one operation key, and
the display controller displays on the display unit the operation screen including a plurality of tab keys indicating the tabs and at least one operation key included in one selected from the tab keys; and, if the input receiving unit receives an input of a tab key that is not selected, displays the operation screen including the tab keys and at least one operation key included in the tab corresponding to the input.

9. The device of claim 6, wherein the reading unit reads out the user ID from a tag including a battery, the tag transmitting the user ID by a power supplied from the battery.

10. The device of claim 6, wherein the reading unit includes an antenna and induces a power to a non-contact IC card including another antenna to read out the user ID from the non-contact IC card.

11. A monitoring and control device used in a remote monitoring and control system including the monitoring and control device and a load control device for controlling one or more loads based on an operation of the monitoring and control device, the monitoring and control device being operated to control the loads, the device comprising:
a reading unit for reading out a user ID;
an authentication unit for performing an authentication based on the user ID;
a display controller for displaying an operation screen for controlling a load on a display unit if the authentication by the authentication unit is succeeded, and suppressing the operation screen from being displayed on the display unit if the authentication is failed;
an input receiving unit for receiving an input through the operation screen; and
a transmission unit for transmitting operation information related to the received input to the load control device.

12. The device of claim 11, wherein the reading unit reads out the user IDs and history information including entering authentication records from a storage medium carried by a user, and
the display controller does not display the operation screen on the display unit if the authentication records included in the history information does not satisfy a predetermined condition even when the authentication by the authentication unit is succeeded.

13. The device of claim 12, wherein, if the authentication records included in the history information do not satisfy the predetermined condition, the display controller displays on the display unit an urging screen for urging users to obtain a normal entering authentication record.

14. The device of claim 13, wherein, if the authentication records included in the history information does not satisfy the predetermined condition, notification information indicating an abnormal access is transmitted to a preset target place.

15. The device of claim 11, further comprising:
an obtaining unit for obtaining an operation state of each load,
wherein the operation screen displayed by the display unit further includes the obtained operation states.

16. The device of claim 11, wherein the reading unit reads out the user ID from a tag including a battery, the tag transmitting the user ID by a power supplied from the battery.

17. The device of claim 11, wherein the reading unit includes an antenna and induces a power to a non-contact IC card including another antenna to read out the user ID from the non-contact IC card.
